(19) United States
(12) Patent Application Publication
(10) Pub. No.: US 2025/0316757 A1
(43) Pub. Date: Oct. 9, 2025

(54) ELECTROLYTE SOLUTIONS

(71) Applicant: Sumitomo Chemical Co., Ltd, Tokyo (JP)

(72) Inventors: Florence Bourcet, Godmanchester (GB); Kanika Aggarwal, Godmanchester (GB); Konrad Zalewski, Godmanchester (GB)

(73) Assignee: Sumitomo Chemical Co., Ltd, Tokyo (JP)

(21) Appl. No.: 19/171,584

(22) Filed: Apr. 7, 2025

(30) Foreign Application Priority Data
Apr. 8, 2024 (GB) 2405001.5

(51) Int. Cl. H01M 10/0565

(52) U.S. Cl. CPC H01M 10/0565; H01M 2300/0085

(57) ABSTRACT

A solution comprising a solvent, a fluorinated polymer and an alkali or alkali earth metal salt wherein the fluorinated polymer is a partially unsaturated poly(alkylene) polymer.

### CROSS REFERENCE TO RELATED APPLICATIONS

This application claims the benefit of and priority to United Kingdom Patent Application No. 2405001.5, filed Apr. 8, 2024, the disclosure of which is incorporated herein by reference in its entirety.

### BACKGROUND

Rechargeable metal ion batteries, in particular lithium-ion metal batteries, are widely used. Lithium metal batteries have also attracted interest due to their high energy density.

WO2023000113A1 discloses a lithium ion battery comprising a gel polymer electrolyte.

Fabrication of a porous polymer electrolyte from poly(vinylidene fluoride-hexafluoropropylene) via one-step reactive vapor-induced phase separation for lithium-ion battery, Wang, Yugang & Xiong, Xiaopeng, Journal of Materials Science, 2023, 58, 1-17, DOI: 10.1007/s10853-023-08326-5 discloses an ammonia water vapor-induced phase separation to fabricate a polymer electrolyte membrane from poly(vinylidene fluoride-hexafluoropropylene) (PVDF-HFP).

Anion Receptor Enhanced Li Ion Transportation for High-Performance Lithium Metal Batteries, Zhixin Wang, Zhipeng Cai, Meinan Liu, Fuliang Xu, and Fangmin Ye, ACS Omega 2023, 8 (18), 16411-16418, DOI: 10.1021/acsomega.3c01258 discloses a gel polymer electrode membrane composed of a cross-linked polyethyleneimine (PEI) poly(vinylidene fluoride-hexafluoropropylene) (PVDF-HFP) and electrolyte.

Tissue paper-based composite separator using nano-SiO2 hybrid crosslinked polymer electrolyte as coating layer for lithium ion battery with superior security and cycle stability, Xinyu Zeng, Yu Liu, Rulei He, Tongyuan Li, Yuqin Hu, Cheng Wang, Jing Xu, Luoxin Wang and Hua Wang, Cellulose, 2022, 29, 3985-4000, DOI: 10.1007/s10570-022-04499-5 discloses a crosslinked binder on tissue paper to adhere nano-SiO2 through chemical reactions between poly(vinylidene fluoride-co-hexafluoropropylene) (PVDF-HFP) and hyperbranched polyethyleneimine (PEI).

Modified Poly(vinylidene fluoride-co-hexafluoropropylene) Polymer Electrolyte Polymer Electrolyte for Enhanced Stability and Polymer Degradation Inhibition toward the Li Metal Anode, Maoxia Yang, Baiqing Zhao, Jianying Li, Shaomin Li, Gen Zhang, Shiqi Liu, Yanhua Cui, and Hao Liu, ACS Applied Energy Materials, 2022, 5 (7), 9049-9057, DOI: 10.1021/acsaem.2c01505 discloses a solid electrolyte formed by in situ dehydrofluorination PVDF-HFP.

Dehydrofluorination Process of Poly(vinylidene difluoride) PVDF-Based Gel Polymer Electrolytes and Its Effect on Lithium-Sulfur Batteries, Julen Castillo, Adrian Robles-Fernandez, Rosalía Cid, José Antonio González-Marcos, Michel Armand, Daniel Carriazo, Heng Zhang and Alexander Santiago, Gels, 2023, 9, 336. DOI: 10.3390/gels9040336 discloses PVDF-based gel polymer electrolytes comprising lithium nitrate.

WO2024/000061A1 discloses a method for producing a single-ion conducting polymer comprising grafting a thiol functionalized conductor compound onto a polymer.

High-performance poly(vinylidenefluoride-co-hexafluoropropylene) based electrospun polyelectrolyte mat for lithium-ion battery, Shahitha Parveen Jakriya, Abdul Majeed Syed, Sindhu Krishna Pillai, and Daulath Banu Rahim, Mater. Express, 2018, 8 (1), 77-84, DOI: 10.1166/mex.2018.1405 discloses chemically modified PVDF-HFP to obtain functionalized material for the preparation of electrolytes suitable for application in Lithium polymer battery. Sulphonated PVdF-HFP was prepared by dehydrofluorination which was carried out by immersing the PVdF-HFP in a KOH solution.

### SUMMARY

The present disclosure provides a solution comprising a solvent, an alkali or alkali earth metal salt, and a dehydrofluorinated polymer. The solutions described herein may be deposited to form a gel electrode layer. The gel layer may be disposed between a first current collector and a second current collector as a method of forming a battery or battery precursor.

In some embodiments, the present disclosure provides a solution comprising a solvent, a fluorinated polymer and an alkali or alkali earth metal salt wherein the fluorinated polymer is a partially unsaturated poly(alkylene) polymer.

Optionally, the fluorinated polymer is a copolymer comprising first alkylene repeat units and second alkylene repeat units wherein at least some of the first alkylene repeat units are unsaturated and the second alkylene repeat units are saturated.

Optionally, the first alkylene repeat units are vinylene difluoride repeat units, at least some of which are dehydrofluorinated.

Optionally, the second alkylene repeat units are saturated hexafluoropropene repeat units.

Optionally, at least 0.1 mol % of the repeat units of the fluorinated polymer, and optionally at least 0.5 mol % of the repeat units of the fluorinated polymer, are unsaturated. The mol % of unsaturated repeat units may be as determined by integration of the ¹H NMR spectrum of the polymer.

Optionally, the alkali or alkali earth metal salt is selected from:

M⁺PF₆₋; M⁺BF₄; ₋M⁺ClO₄⁻; M⁺BOB; M⁺TSFI⁻; and a compound of formula (I):

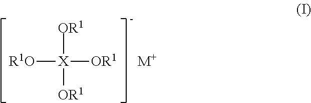

wherein:
M⁺ is an alkali or alkali earth metal cation;
X is Al or B; and
R¹ in each occurrence is independently a substituent wherein two R¹ groups may optionally be linked to form a ring.

Optionally, each R¹ is independently selected from C₁₋₂₀ alkyl wherein one or more non-adjacent C atoms other than the C atom directly bound to O of the borate or aluminate may be replaced with O and one or more H atoms may be replaced with F; C₆₋₂₀ aryl which may be optionally substituted; and C₁₋₂₀ alkylene-C₆₋₂₀ aryl wherein one or more non-adjacent C atoms of the C₁₋₂₀ alkylene other than the C atom bound to O of the borate may be replaced with O and one or more H atoms of the C₁₋₂₀ alkylene may be replaced with F, and the C₆₋₂₀ aryl may be unsubstituted or substituted.

Optionally, the R¹ groups are not linked, wherein each occurrence of R¹ is independently a C₁₋₂₀ alkyl group wherein one or more non-adjacent C atoms of the alkyl group may be optionally replaced with O and one or more H atoms of the alkyl group may be replaced with F.

Optionally, the alkali or alkali earth metal salt is a lithium salt.

Optionally, the solution comprises one or more solvents selected from the group consisting of alkylene carbonates, dialkyl carbonates and ethers.

Optionally, the solution comprises one or more solvents selected from PC, DME, and DMC.

Optionally, the solution does not comprise a base, for example an amine.

In some embodiments, the present disclosure provides a method of forming a gel electrolyte comprising deposition of a solution as described herein and evaporating the solvent.

Optionally, the gel electrolyte comprises no more than 12 solvent molecules per M⁺ cation.

In some embodiments, the present disclosure provides a method of forming a battery or battery precursor comprising a gel layer disposed between a first current collector and a second current collector wherein formation of the gel layer comprises deposition of a solution as described herein and evaporation of the solvent.

Optionally, the gel layer is formed over the first current collector and wherein the second current collector is formed over the gel layer.

### DESCRIPTION OF DRAWINGS

FIG. 1 illustrates a metal battery or metal ion battery according to some embodiments of the present disclosure;

FIG. 2 shows ¹H NMR spectra (600 MHZ) in DMSO-d₆ of PVDF-HFP (bottom) compared to the dehydrofluorinated polymer obtained at precipitation time intervals of 3, 5, and 6 hours;

FIG. 3A is the Nyquist plots for Comparative Gel 1 and Gel Example 1;

FIG. 3B is a zoomed-in Nyquist plot of FIG. 3A;

FIG. 4 is an illustrative EIS spectrum;

FIG. 5 is an illustrative DC measurement of current and voltage vs. time;

FIG. 6 shows current density measurement (current and voltage vs. time) for Comparative Gel 1; and

FIG. 7 is a schematic illustration (side view) of a sample gel mounted in an Imperial 2500 tester.

The drawings are not drawn to scale. The drawings are some implementations and examples. While the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. References to a layer “over” another layer when used in this application means that the layers may be in direct contact or one or more intervening layers may be present. References to a layer “on” another layer when used in this application means that the layers are in direct contact. References to an element of the Periodic Table include any isotopes of that element.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

The present disclosure provides a solution comprising a solvent, a fluorinated polymer and an alkali or alkali earth metal salt wherein the fluorinated polymer is a partially unsaturated poly(alkylene) polymer.

The solution may be used to form a gel electrolyte by evaporation of some, but not all, of the solvent. A polymer having a desired extent of dehydrofluorination may be used in forming the solution. In contrast, allowing a fluorinated polymer to dehydrofluorinate in-situ in the solution may make it hard to control the extent of dehydrofluorination and may limit shelf life of the solution, e.g., due to crosslinking side-reactions during dehydrofluorination.

Accordingly, a solution as described herein preferably does not comprise a base, for example an amine.

### Solvents

Exemplary solvents of the solution include, without limitation, C₂₋₁₀ alkylene carbonates, di(C₁₋₁₀ alkyl) carbonates, for example propylene carbonate, ethylene carbonate, dimethyl carbonate, diethyl carbonate; linear, branched or cyclic compounds containing one ether group, for example diethyl ether or tetrahydrofuran; di(C₁₋₆ alkyl) ketones, for example acetone; linear, branched or cyclic compounds containing two or more ether groups, for example 1,3-dioxolane, 2,5-dimethoxy tetrahydrofuran, glyme (dimethoxyethane), diglyme, diethylene glycol diethyl ether (DEGDE), triglyme and tetraglyme; cyclic lactones and mixtures thereof.

### Polymer

The solution of the present disclosure comprises a partially unsaturated, fluorinated poly(alkylene) polymer. This polymer is preferably a dehydrofluorinated homopolymer or copolymer of one or more fluorinated alkenes. Exemplary fluorinated alkenes include, without limitation, polymers of vinylidene difluoride (VDF), trifluoroethylene, tetrafluoroethylene, hexafluoropropylene (HFP) and combinations thereof. Preferably, the polymer is dehydrofluorinated PVDF_HFP.

In some embodiments, the partially unsaturated, fluorinated poly(alkylene) polymer is the only polymer of the solution.

In some embodiments, the solution comprises one or more further polymers, The one or more further polymers may be selected from ion-conducting polymers including, without limitation: poly(alkylene oxide), for example poly(ethylene oxide) and poly(propylene oxide); and fluorinated polymers such as PVDF, PVDF-HFP; PMMA; polyacrylonitrile; polycarbonate; polyethylene; poly(vinyl polypropylene; methyl ketone); polyvinylpyrrolidone; polyether ether ketone; polyisoprene; polybutadiene; polystyrene-block-polyisoprene-block-polystyrene; poly(l-vinylpyrrolidone-co-vinyl acetate); polystyrene-block-polybutadiene-block-polystyrene; polystyrene-block-poly(ethylene oxide)-block-polystyrene; co-polymer and mixtures thereof.

The one or more further polymers are suitably neutral polymers, i.e., not a polymer substituted with ionic groups, and in particular are suitably not single-ion conducting polymers comprising anionic groups.

In some embodiments, the one or more further polymers may be substituted with a crosslinkable group, for example a polymer substituted with a crosslinkable carbon-carbon double bond group, for example a polymer substituted with a methacrylate or acrylate group. In some embodiments, the solution comprises monomers capable of forming a crosslinked network after polymerisation, for example a monomer containing two polymerizable groups such as two polymerizable carbon-carbon double bond groups.

Optionally, the solids content (dissolved or dispersed) polymer in a solution as described herein is in the range of 30-70 mg/mL.

Optionally, the alkali or alkali earth metal salt: polymer weight ratio is in the range of 90:10 to 70:30.

The polystyrene-equivalent number-average molecular weight (Mn) measured by gel permeation chromatography of the polymer may be in the range of about 1×10³ to 1×10⁸, and preferably 1×10⁴ to 5×10⁵. The polystyrene-equivalent weight-average molecular weight (Mw) of the polymers described herein may be 1×10³ to 1×10⁸, and preferably 5×10³ to 1×10⁶.

The partially unsaturated fluorinated polymer may be formed by dehydrofluorination of a fluorinated polymer. Dehydrofluorination may be effected by treatment of a solution of the fluorinated polymer with a base, for example an amine such as 1,1,4,7,10,10-Hexamethyltriethylenetetramine (HMTETA). The extent of dehydrofluorination may be monitored by any suitable means, such as 1H NMR, and the reaction may be stopped when a desired degree of dehydrofluorination has been achieved. The reaction may be stopped by separating the polymer from the base, for example by contacting the solution with an antisolvent to precipitate the dehydrofluorinated polymer, for example a protic solvent such as an alcohol, e.g. methanol, water, or a mixture thereof.

### Alkali or Alkali Earth Metal Salt

The alkali or alkali earth metal salt of the solution may be, for example, M⁺PF₆₋, M⁺BF₄₋, M⁺ClO₄⁻, alkali metal bis(oxalato) borate (M⁺BOB⁻), alkali metal bis(trifluoromethanesulfonyl)imide (M⁺TSFI⁻) wherein M⁺ is an alkali or alkali earth metal cation preferably an alkali metal cation, more preferably a lithium cation, or a compound of formula (I):

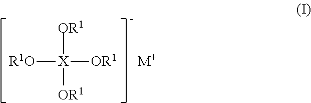

wherein:
X is Al or B;
M⁺ is an alkali or alkali earth metal cation, preferably an alkali metal cation, more preferably Li⁺; and
R¹ in each occurrence is independently a substituent wherein two R¹ groups may be linked to form a ring.

Preferably, the alkali or alkali earth metal salt is a compound of formula (I).

Preferably, each R¹ is independently selected from:
(C═O) n-C₁₋₂₀ alkyl wherein n is 0 or 1 and one or more non-adjacent C atoms other than the C atom directly bound to O of the borate or aluminate (in the case where n is 0) may be replaced with O and one or more H atoms may be replaced with F;
an optionally substituted C₆₋₂₀ aryl; and
C₁₋₂₀ alkylene-C₆₋₂₀ aryl wherein one or more non-adjacent C atoms of the C₁₋₂₀ alkylene other than the C atom bound to O of the borate may be replaced with O and one or more H atoms of the C₁₋₂₀ alkylene may be replaced with F, and the C₆₋₂₀ aryl may be unsubstituted or substituted.

Where present, substituents of the C₆₋₂₀ aryl are preferably and independently selected from substituents R⁵ wherein R⁵ in each occurrence is independently selected from the group consisting of F and C₁₋₁₂ alkyl wherein one or more non-adjacent, non-terminal C atoms of the C₁₋₁₂ alkyl may be replaced with O, S, NR⁴, CO COO or CONR⁴ wherein R⁴ in each occurrence is independently a C₁₋₁₂ hydrocarbyl group, and one or more H atoms of the C₁₋₁₂ alkyl group may be replaced with F.

By “non-terminal C atom” of an alkyl chain as used herein is meant the methyl group at the chain end of a linear alkyl chain or each one of the methyl groups at the chain ends of a branched alkyl group.

A C₁₋₁₂ hydrocarbyl group as described anywhere herein is preferably selected from C₁₋₁₂ alkyl; phenyl; and phenyl substituted with one or more C₁₋₆ alkyl groups.

In the case where none of the R¹ groups are linked, preferably each R¹ independently in each occurrence is a C₁₋₂₀ alkyl group wherein one or more non-adjacent C atoms of the alkyl group, other than the C atom bound to the O atom of the aluminate or borate, may be replaced with O and one or more H atoms of the alkyl group may be replaced with F.

In some embodiments, two pairs of R¹ groups are linked and the compound of formula (I) has formula (II):

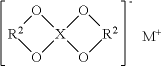

R² in each occurrence is independently a divalent organic group.

Preferably, R² is selected from:
unsubstituted or substituted C₆₋₂₀ arylene;
unsubstituted or substituted C₁₋₂₀ alkylene wherein one or more non-adjacent C atoms other than the C atoms directly bound to O of the borate or aluminate may be replaced with O and one or more H atoms may be replaced with F; and
C₁₋₂₀-alkylene-C₆₋₂₀ arylene wherein one or more non-adjacent C atoms of the C₁₋₂₀ alkylene other than the C atoms bound to O of the borate or aluminate may be replaced with O, the C₁₋₂₀-alkylene is unsubstituted or substituted; and the C₆₋₂₀ arylene is substituted or unsubstituted.

The C₆₋₂₀ arylene may be unsubstituted or substituted with one or more substituents. Preferred substituents, where present, are selected from R⁵ as described above.

R² is preferably selected from: Ar¹ wherein Ar¹ in each occurrence is independent an optionally substituted C₆₋₂₀ arylene group, e.g. 1,2-phenylene, which may be unsubstituted or substituted with one or more substituents; a bi-arylene group of formula Ar¹—Ar¹, for example 2,2′-linked biphenylene which may be unsubstituted or substituted with one or more substituents; ethylene; propylene; and a group of formula (III):

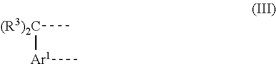

wherein R³ in each occurrence is H, F or a C₁₋₆ alkyl in which one or more H atoms may be replaced with F; and Ar¹ is a C₆₋₂₀ arylene group, preferably unsubstituted or substituted 1,2-phenylene.

In a preferred embodiment, at least one R³, optionally each R³, is a C₁₋₆ perfluoroalkyl group.

Preferably, each Ar¹ of formula (I) is phenylene, more preferably a 1,2-linked phenylene which is unsubstituted or substituted with one or more substituents.

Where present, substituents of Ar¹ are preferably and independently selected from R⁵ as described above

The compound of formula (I) may comprise a solvated M⁺ cation.

Optionally, the electrolyte as present in a battery contains no more than 16 solvent molecules per M⁺ cation, preferably no more than 12. The solvent/M⁺ ratio may be as determined from a ¹H NMR spectrum of the electrolyte prior to its incorporation into a battery.

### Gel Electrolyte Formation

A gel electrolyte may be formed by depositing a solution comprising a composition as described herein onto a surface and evaporating some, but not all, of the solvent present in the solution.

Evaporation is preferably by heating, optionally at a temperature in the range of 30-100° C. Evaporation temperature and time may be selected according to the required quantity of solvent in the gel and the boiling point(s) of the solvent(s). The amount of solvent(s) remaining in the gel after solvent evaporation may be determined by ¹H NMR analysis.

Optionally, the gel electrolyte is crosslinked following deposition. The deposited solution may comprise a crosslinkable material such as a crosslinkable polymer or a monomer which polymerises to form a crosslinked polymer.

Exemplary groups of a monomer or a crosslinkable polymer for forming a crosslinked polymer include, without limitation, epoxy groups and groups containing a reactive carbon-carbon double bond. The reactive carbon-carbon double bond may be a carbon-carbon double bond of a strained cyclic group, for example norbornene or cyclobutene. The reactive carbon-carbon double bond may be an acyclic carbon-carbon double bond, preferably a group of formula —CR⁶═CH₂ wherein R⁶ is H or a substituent, for example a group of a methacrylate or acrylate.

A polymer may be substituted with a crosslinkable group which reacts to crosslink polymer chains.

A monomer may contain two or more crosslinkable groups which react to form a crosslinked polymer.

### Battery

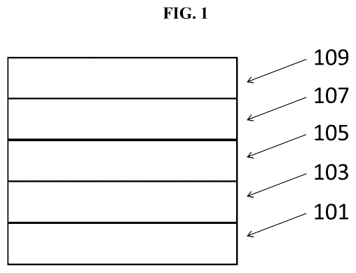

FIG. 1 illustrates a battery. The battery may be a metal battery or a metal ion battery. The metal of the metal battery or metal ion battery is preferably an alkali or alkali earth metal, more preferably an alkali metal, most preferably Li or Na. The battery is suitably a secondary (rechargeable) battery.

The battery comprises an anode current collector 101 in contact with an anode 103 on a surface thereof; a cathode current collector 109 in contact with a cathode 107; and a layer 105 comprising or consisting of an electrolyte as described herein disposed between the anode and cathode.

In some embodiments, layer 105 is a gel layer comprising a polymer; a solvent; and a compound of formula (I).

In some embodiments, layer 105 is a porous separator comprising an electrolyte as described herein absorbed into the porous separator.

In the case of a metal ion battery, the anode comprises an active material, e.g., graphite, for absorption of the metal ions.

In the case of a metal battery, the anode 103 is a layer of metal which is formed over the anode current collector during charging of the battery and which is stripped during discharge of the battery.

The cathode may be selected from any cathode known to the skilled person.

The anode and cathode current collectors may be any suitable conductive material known to the skilled person, e.g. one or more layers of metal or metal alloy such as aluminium or copper.

For simplicity, FIG. 1 illustrates a battery in which the anode and cathode are separated only by a layer comprising or consisting of the electrolyte, however it will be understood that in use a solid-electrolyte interphase will typically form on the anode surface.

In other embodiments, one or more further layers may be disposed between the anode and the electrolyte and/or the cathode and the electrolyte.

### EXAMPLES

### I. Material Synthesis

Dehydrofluorination with HMTETA

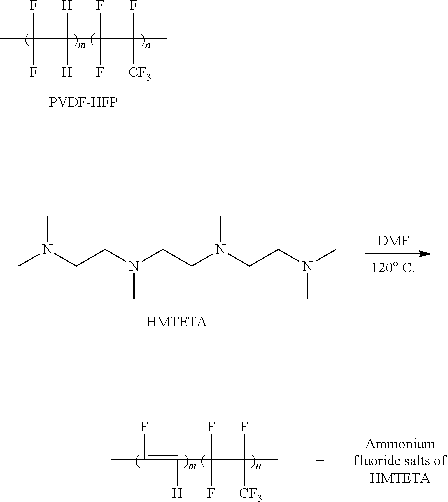

PVDF-HFP (1 g, 4.67 mmol of monomer unit) was placed in a 50 mL round bottom flask, which was securely sealed with a septum and purged with nitrogen. Subsequently, 10 mL of dry DMF was added, and the reaction mixture was purged for 30 minutes. 1,1,4,7,10,10-Hexamethyltriethylenetetramine, HMTETA (126 μL, 467 μmol) was then added, and the degassing process continued at room temperature for 30 minutes. The temperature of the flask was then raised to 120° C. The colour of the reaction mixture gradually changed from light brown to dark brown.

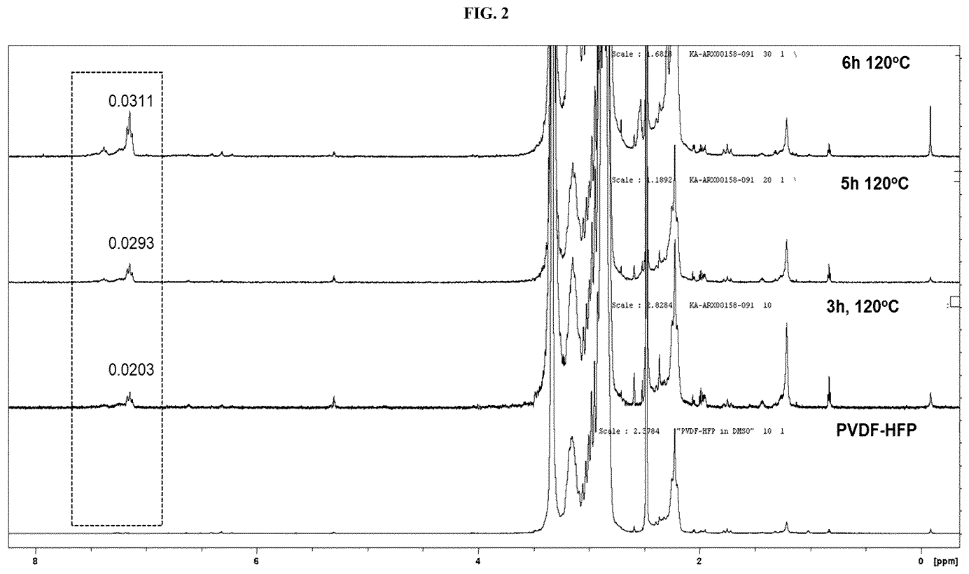

At intervals of 3 and 5 hours, a 2.5 mL aliquot of the reaction aliquot was taken and precipitated in water, followed by washing with methanol. The reaction flask was further heated for an additional hour, and the reaction mixture was once again precipitated in water and washed with methanol. NMR (FIG. 2) is used for characterization, and the resulting product was dried under vacuum at 50° C.

A distinct peak around 7.2 ppm appears, indicating the formation of double bonds resulting from the dehydrofluorination process of PVDF-HFP. Moreover, as the reaction time increases, the intensity of the peak at 7.2 ppm also increases, suggesting a higher extent of dehydrofluorination.

### Gel Formulations Using LiB(HPP)2 Ionic Liquid and Incorporating DHF-PVDF-HFP as Matrix

### Gel Example 1

Lithium Salt 1 with 6 molecules of PC per lithium ion (427.4 mg) and DHF-PVDF-HFP solution (700 μl, 50 mg/ml in dimethyl carbonate), were mixed to yield solution 1.

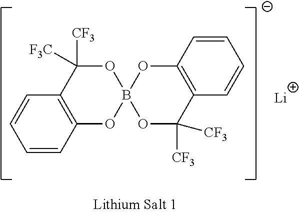

225 μl of solution 1 were drop-casted on a stainless steel disc (diameter 16 mm) placed on a hotplate set at 30° C. This temperature was maintained for 10 minutes then the disc was removed from the hotplate and covered with a coin cell top to cool down to room temperature for 5 minutes. This step was done for 2 more discs and the resulting casted electrodes were used for cell testing.

### Comparative Gel 1

Lithium Salt 1 with 6 molecules of PC per lithium ion (488.4 mg), PVDF-HFP solution (400 μl, 100 mg/ml in dimethyl carbonate) and dimethyl carbonate (200 μl) were mixed to yield Comparative Solution 1.

200 μl of Comparative solution 1 was drop-casted on a stainless steel disc (diameter 16 mm) placed on a hotplate set at 30° C. This temperature was maintained for 10 minutes then the disc was removed from the hotplate and covered with a coin cell top to cool down to room temperature for 5 minutes. This step was done for 2 more discs and the resulting casted electrodes were used for cell testing.

### Gel Example 2

Lithium Salt 1 with 6 molecules of PC per lithium ion (334 mg), DHF-PVDF-HFP solution (140 μl, 100 mg/ml in acetone), Poly(ethylene glycol) dimethacrylate Mn550 solution (117 μl, 300 mg/ml in acetone, containing 1.5 w/w % of 1,1′-Azobis(cyclohexanecarbonitrile), propylene carbonate (12 μl) and diethylene glycol diethyl ether, DEGDE (288 μl) were mixed to yield solution 2.

220 μl of solution 2 were drop-casted on a stainless steel disc (diameter 16 mm) placed on a hotplate set at 30° C. Temperature was maintained for 30 minutes then the disc was covered with a coin cell top and temperature was increased to 80° C. to crosslink the methacrylates. This temperature was maintained for 1 hour, after which the disc was removed and left to cool down to room temperature. This step was done for 2 more discs and the resulting casted electrodes were used for cell testing.

### Comparative Gel 2

Lithium Salt 1 with 6 molecules of PC per lithium ion (322.4 mg), PVDF-HFP solution (90 μl, 150 mg/ml in acetone), Poly(ethylene glycol) dimethacrylate Mn550 solution (112.5 μl, 300 mg/ml in acetone, containing 1.5 w/w % of 1,1′-Azobis(cyclohexanecarbonitrile)), propylene carbonate (12 μl) and diethylene glycol diethyl ether, DEGDE (303 μl) were mixed to yield Comparative solution 2.

210 μl of Comparative solution 2 were drop-casted on a stainless steel disc (diameter 16 mm) placed on a hotplate set at 30° C. This temperature was maintained for 30 minutes then the disc was covered with a coin cell top and temperature was increased to 80° C.

This temperature was maintained for 1 hour, after which the disc was removed from the hotplate and left to cool down to room temperature. This step was done for 2 more discs and the resulting casted electrodes were used for cell testing.

Gels containing DHF_PVDF-HFP were tougher and more stretchable than the ones obtained from PVDF-HFP whilst not being detrimental for device performances.

Dehydrofluorination with Branched Polyethylenimine, PEI

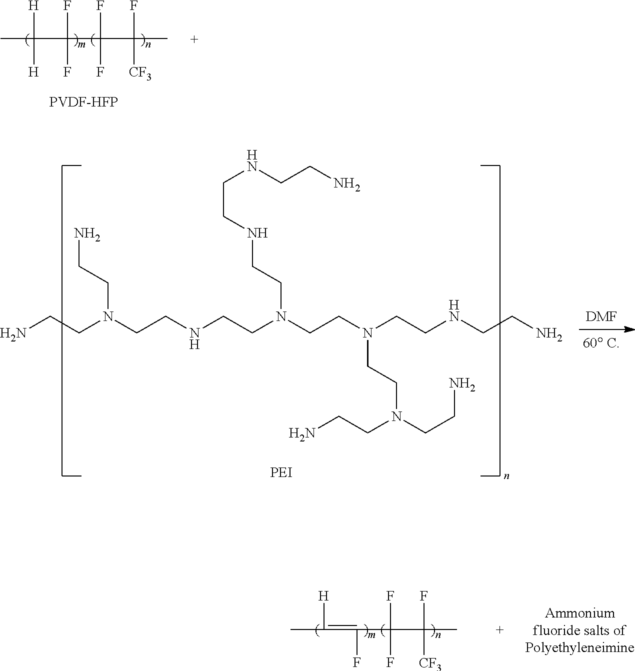

PVDF-HFP (1 g, 4.67 mmol of monomer unit) was placed in a 50 mL round bottom flask securely sealed with a septum and purged with nitrogen. Dry DMF (10 mL) was added to the flask, and the reaction mixture was purged for 30 minutes. Subsequently, branched PEI (0.09 mL, Mw˜800, Mn˜600) was introduced, and the reaction mixture was further degassed for 30 minutes at room temperature. Once degassing was complete, the flask was heated to 60° C. Over time, the colour of the reaction mixture gradually changed, initially turning yellow within the first 5 minutes and eventually darkening to brown. After 20 minutes, the viscosity of the reaction mixture increased, and an additional 5 minutes later, the polymer solidified, forming a gel. The polymer obtained was insoluble, making it unsuitable for NMR characterization and its sticky nature prevented characterization using IR. Despite washing the polymer with methanol and water and subsequent drying, it retained its sticky and flexible nature. Without wishing to be bound by any theory, dehydrofluorination using PEI is accompanied by crosslinking of the polymer, rendering the product insoluble.

### Cell General Method

Cells 1 and 2 were made using gels formed from Solutions 1 and 2, respectively. For comparison, cells were made in the same way using Comparative Gels 1 and 2.

For each of the stainless steel disks carrying a gel film as described above, the gel film was cut into a 9 mm diameter circle using a manual disc cutter (purchased from Cambridge Energy Solutions) and a 360 micron thick silicone stencil (purchased from Silex Silicones), shaped as a disk of 16 mm diameter with a circular hole of 9 mm diameter cut in its middle was placed to surround the gel film.

A saturated solution of silver nitrate in dimethyl carbonate was reduced with small pieces of metallic lithium foil, by stirring overnight using a magnetic stirrer bar at RPM>900. The reaction resulted in the formation of a finely dispersed, grey-black powder that was collected and dried in a Petri dish at room temperature. An ETFE mesh was dipped into the dried grey-black powder in the Petri dish and was gently polished onto the surface of a pre-polished lithium disk without native oxide layer. This treatment resulted in a colour change due to the formation of a smooth, thin layer of silver-lithium alloy on the surface of the lithium disk.

Cells were fabricated in a rigorously dry and oxygen-free Argon gas-filled MBraun glovebox using casings purchased from Cambridge Energy Solutions.

2032-type coin cells were formed by inserting a stainless-steel spacer in a coin cell bottom, followed by, in sequence, a steel disk carrying the dried gel and silicone spacer, the Ag—Li modified lithium disk with the modified surface contacting the gel, a stainless steel spacer, a wave spring and a coin cell top. The assembled structure was crimped.

### Results

Electrochemical Impedance Spectroscopy (EIS) measurements were conducted at room temperature. Impedances were taken over a frequency range of 1 Hz to 1 MHZ, with an amplitude of 5 mV.

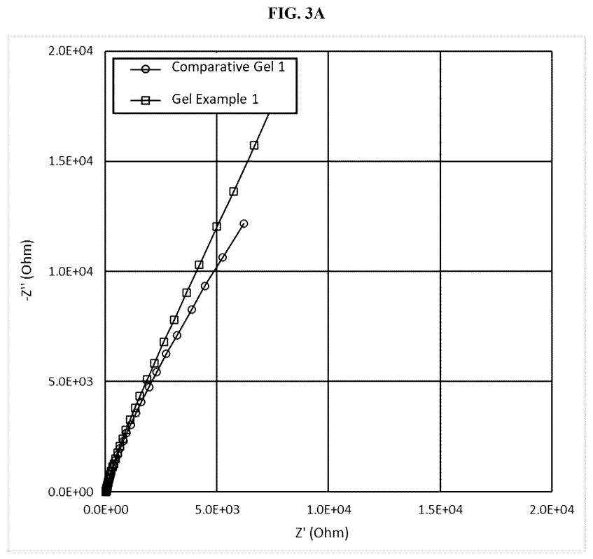

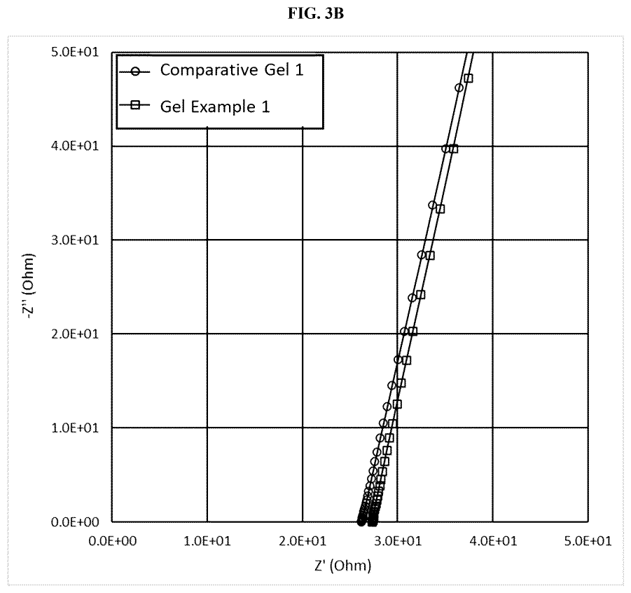

Nyquist plots are given for Comparative Gel 1 and Gel Example 1 in FIGS. 3A and 3B.

Each cell was fitted with a R—(R-Wi, CPE) equivalent circuit. The first R circuit component was taken as the impedance of the electrolyte.

The limiting current density, i.e., the highest unidirectional current density that a given electrolyte material can sustain over an extended period of time, was determined by measuring the voltage as a function of time, during successive plating and stripping cycles at stepwise increased current densities.

The measurements were performed with coin cells, using the Arbin battery testing system (Arbin Instruments).

The Lithium plating and stripping cycles were carried out as follows:
1. Application of an initial plating current (which corresponds to current density of 0.94 mA/cm²) for 1 hour, followed by
2. Application of an initial stripping current (which corresponds to current density of −0.94 mA/cm²) for 1 hour.
3. Following this, both steps (1) & (2) were repeated five times in total.
4. Next, the applied “plating” & “stripping” currents were increased to achieve 0.24 mA/cm² increase in the corresponding current density.
5. Following this, the cell was cycled five times at this higher level.
6. Steps (4) & (5) were repeated until measured voltage started to be unstable.

TABLE 1

| Gel | Impedance [Ohm] |
|---|---|
| Comparative Ge1 1 | 26.2 |
| Gel example 1 | 27.4 |

The impedances Comparative Gel 1 and Gel Example 1 are similar.

### Lithium Transference Number (LTN)-Measurements and Results

The LTNs were measured according to Evans's method (J. Evans et al., POLYMER, 1987, Vol 28), using the same device configuration as described above.

Prior to LTN measurement, the Lithium unidirectional plating on the stainless steel disk with gel was carried out for each cell. Used the Arbin battery testing system (Arbin Instruments) and followed steps:
1. Application of an initial plating voltage of 50 mV 1 hour, followed by
2. Application of the plating voltage of 100 mV for 1 hour, followed by
3. Application of the plating voltage of 150 mV for 1 hour, followed by
4. Application of the final plating voltage of 200 mV for 1 hour.

Devices were left resting for about 13 hours before performing the LTN measurement, in order to ensure stabilisation of the interfaces between the electrolyte and both electrodes.

After resting:
1. A first EIS spectrum was measured (used Gamry 1010E Potentiostat).
2. This was followed by a DC current measurement with the applied 50 mV constant voltage (Arbin battery testing system). The measurement was terminated as soon as the current had decreased to a steady state.
3. The sequence was then finished with a second EIS measurement.

The EIS measurements were conducted at room temperature. The EIS measurements were taken over a frequency range of 1 Hz to 1 MHZ, with an amplitude of 5 mV.

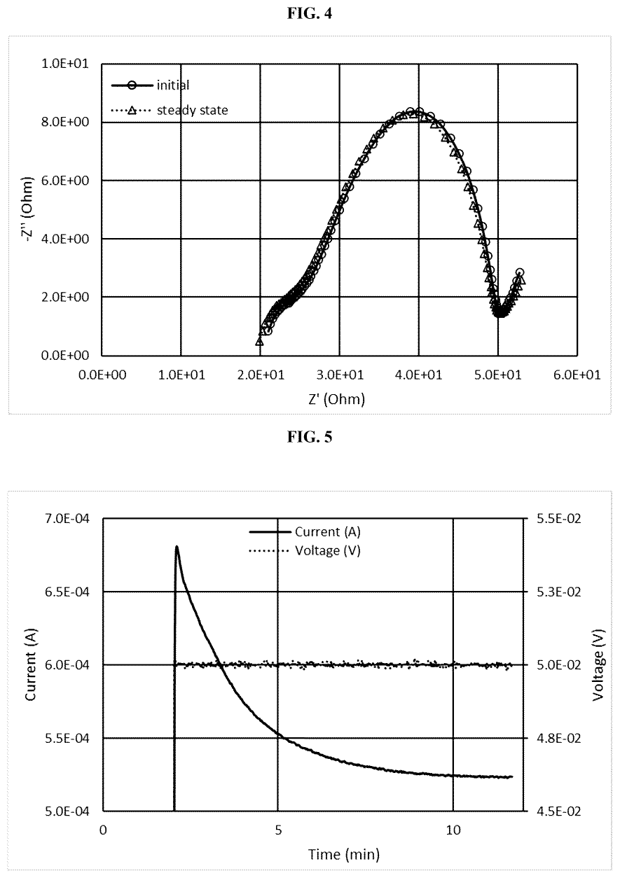

The LTN values were calculated according to the following formula, based on the model developed by Evans et al.:

$$LTN = \frac{{I}^{s} ( Δ V - {I}^{0} {R}^{0} )}{{I}^{0} ( Δ V - {I}^{s} {R}^{s} )}$$

where (FIGS. 4 and 5):
1. R⁰ is the initial impedance taken from the first EIS spectrum (determined by estimating the intercept on the x-axis of the Nyquist plot of the second semicircle (right hand side)).
2. R^{s} is the steady state impedance taken from the second EIS after a DC bias was applied (determined by estimating the intercept on the x-axis of the Nyquist plot of the second semicircle (right hand side)).
3. I⁰ is the initial current taken when the voltage is stepped to set value.
4. I^{s} is the steady state current taken at the end of the DC measurement.

After measurements, LTN was calculated for each type of cell (Table 2). The values for the gels with PVDF-HFP and DHF-PVDF-HFP are very similar.

TABLE 2

| Gel | LTN |
|---|---|
| Comparative Ge1 1 | 0.62 |
| Gel example 1 | 0.64 |

### Limiting Current Density (LC)-Measurements and Results

The limiting current density is the highest unidirectional current density that a given electrolyte material can sustain over extended periods of time.

It is determined by measuring the voltage as a function of time, during successive plating and stripping cycles at stepwise increased current densities.

The measurements were performed with coin cells, using the Arbin battery testing system (Arbin Instruments).

The Lithium plating and stripping cycles were carried out as follows:
7. Application of an initial plating current (which corresponds to current density of 2.2 mA/cm²) for 1 hour, followed by
8. Application of an initial stripping current (which corresponds to current density of −2.2 mA/cm²) for 1 hour.
9. Following this, both steps (1) & (2) were repeated five times in total.
10. Next, the applied “plating” & “stripping” currents were increased to achieve 0.2 mA/cm² increase in the corresponding current density.
11. Following this, the cell was cycled five times at this higher level.
12. Steps (4) & (5) were repeated until measured voltage started to be unstable.

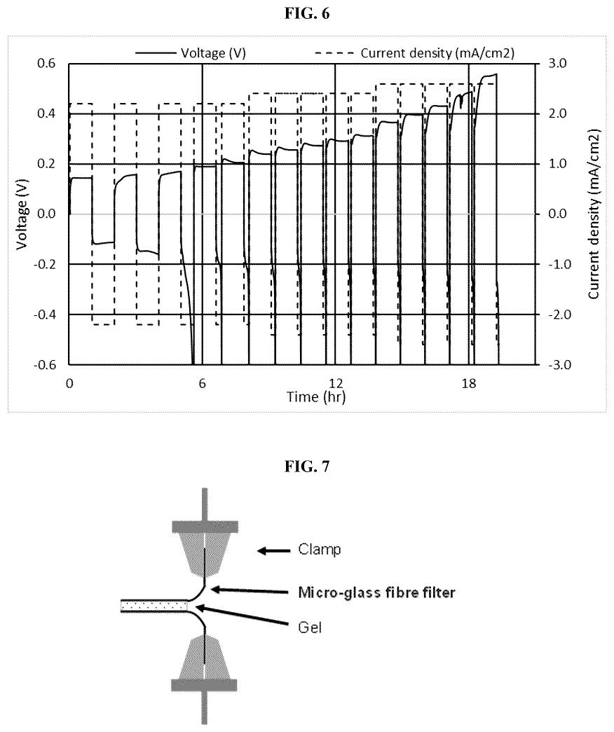

Example of the limiting current measurements for coin cells with PVDF-HFP gel (Comparative Gel 1 is shown in FIG. 6. At the current density level of 2.6 mA/cm², voltage started to increase rapidly in each consecutive “plating” cycle and some instability appeared. Based on these facts, the limiting current density for the gel with PVDF-HFP (Comparative Gel 1, is 2.4 mA/cm2.

After measurements, the limiting current density was determined for each type of cell (Table 3). The values for Gel Example 1 and Comparative Gel 1 are similar.

TABLE 3

| | Limiting current |
|---|---|
| Gel | density [mA/cm²] |
| Comparative Ge1 1 | 2.40 |
| Gel example 1 | 2.27 |

For the gel where the ratio of Lithium Salt 1: matrix is 85:15, the impact of replacing PVDF-HFP with its dehydrofluorinated analog (DHF_PVDF-HFP) on a gel impedance, LTN and limiting current density is very small.

The impedance, LTN and limiting current density of the electrolyte (Tables 4 to 6) were measured using techniques described in the previous paragraph for Gel Example 2 and Comparative Gel 2 for which the Lithium Salt 1: Polymer weight ratio is 76:24.

TABLE 4

| Gel | impedance [Ohm] |
|---|---|
| Comparative Gel 2 | 33 |
| Gel Example 2 | 45 |

TABLE 5

| Gel | LTN |
|---|---|
| Comparative Gel 2 | 0.68 |
| Gel Example 2 | 0.39 |

TABLE 6

| | Limiting current |
|---|---|
| Gel | density [mA/cm²] |
| Comparative Gel 2 | 1.54 |
| Gel Example 2 | 1.44 |

### Mechanical Properties

The force needed to pull apart two strips connected by gel was tested.

A frame was made out of a glass base (2 inch square, 0.6 mm thick), a fluorosilicone seal (purchased from Silex Silicones, 2 inch square, 0.4 mm thick) and Teflon top (2 inch square, 1.5 mm thick). Both the silicone seal and the Teflon top had a rectangular hole (30 mm wide, 20 mm long) cut in the middle. The whole stack was secured using Scotch tape (purchased from RC Components, 9 mm wide, 81 μm thick).

The samples were fabricated by inserting a bottom micro-glass fibre filter strip, purchased from Fisher Scientific, product code 11465238, pre-cut to be 30 mm wide and 40 mm long) into the frame opening such that half of the 40 mm strip was in contact with the 20 mm long glass base of the frame opening and the other half of the strip protruded out of the frame. Gel (1 ml) was deposited onto the bottom strip. Next a top micro-glass fibre filter strip with the same dimensions as the bottom strip was placed and aligned with the bottom one. A metal spatula was used to press the stack very gently in the frame opening to establish uniform contact between both strips.

The samples were initially dried on a hotplate (30 minutes at 30° C. for Gel Example 2 and Comparative Gel 2; 15 minutes at 30° C. for Gel Example 1 and Comparative Gel 1), then each individual sample was covered by a Petri dish top (diameter 80 mm, height 10 mm) and dried further (60 minutes at 90° C. for Gel Example 2 and Comparative Gel 2; 10 minutes at room temperature of 22° C. for Gel Example 1 and Comparative Gel 1). The strips were then left to rest for 10 minutes at room temperature (22° C.) before the test was started.

The force needed to pull apart the two strips connected by gel was measured using the Imperial 2500 computer-controlled test stand fitted with the ILC 50N loadcell. The test was performed at 2 mm/sec speed in a configuration displayed in FIG. 7.

All samples were prepared in a rigorously dry and oxygen free Argon gas-filled MBraun glovebox. Follow up measurements were conducted outside the glovebox.

Results are given in Table 7.

| Gel | Matrix | Average force [N] |
|---|---|---|
| Comparative Gel 2 | PVDF-HFP:PEGDMA | 0.15 |
| Gel Example 2 | DHF-PVDF-HFP:PEGDMA | 0.25 |
| Comparative Gel 1 | PVDF-HFP | 0.01 |
| Gel Example 1 | DHF-PVDF-HFP | 0.05 |

Replacing PVDF-HFP with DHF_PVDF-HFP improves gel adhesiveness and stretchability.

What is claimed is:

1. A solution comprising a solvent, a fluorinated polymer and an alkali or alkali earth metal salt wherein the fluorinated polymer is a partially unsaturated poly(alkylene) polymer.

2. The solution according to claim 1 wherein the fluorinated polymer is a copolymer comprising first alkylene repeat units and second alkylene repeat units wherein at least some of the first alkylene repeat units are unsaturated and the second alkylene repeat units are saturated.

3. The solution of claim 1, wherein the first alkylene repeat units are vinylene difluoride repeat units, at least some of which are dehydrofluorinated.

4. The solution according to claim 2, wherein the second alkylene repeat units are saturated hexafluoropropene repeat units.

5. The solution according to claim 2 wherein at least 0.1 mol % of the repeat units of the fluorinated polymer are unsaturated, as determined by ¹H NMR spectroscopy.

6. The solution according to claim 1, wherein the alkali or alkali earth metal salt is selected from:
M⁺PF₆₋; M⁺BF₄; ₋M⁺ClO₄⁻; M⁺BOB; M⁺TSFI⁻; and a compound of formula (I): 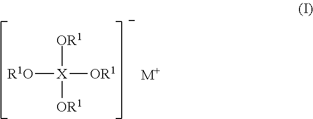
wherein:
M⁺ is an alkali or alkali earth metal cation;
X is Al or B; and
R¹ in each occurrence is independently a substituent wherein two R¹ groups may optionally be linked to form a ring.

7. The solution according to claim 6 wherein each R¹ is independently selected from C₁₋₂₀ alkyl wherein one or more non-adjacent C atoms other than the C atom directly bound to O of the borate or aluminate may be replaced with O and one or more H atoms may be replaced with F; C₆₋₂₀ aryl which may be optionally substituted; and C₁₋₂₀ alkylene-C₆₋₂₀ aryl wherein one or more non-adjacent C atoms of the C₁₋₂₀ alkylene other than the C atom bound to O of the borate may be replaced with O and one or more H atoms of the C₁₋₂₀ alkylene may be replaced with F, and the C₆₋₂₀ aryl may be unsubstituted or substituted.

8. The solution according to claim 6, wherein the R¹ groups are not linked, wherein each occurrence of R¹ is independently a C₁₋₂₀ alkyl group wherein one or more non-adjacent C atoms of the alkyl group may be optionally replaced with O and one or more H atoms of the alkyl group may be replaced with F.

9. The solution according to claim 1, wherein the alkali or alkali earth metal salt is a lithium salt.

10. The solution according to claim 1 wherein the solution comprises one or more solvents selected from the group consisting of alkylene carbonates, dialkyl carbonates and ethers.

11. The solution according to claim 9 wherein the solution comprises one or more solvents selected from PC, DME, and DMC.

12. The solution according to claim 1 wherein the solution does not contain a base.

13. A method of forming a gel electrolyte comprising deposition of a solution according to claim 1 and evaporating the solvent.

14. The method according to claim 13 wherein the gel electrolyte comprises no more than 12 solvent molecules per M+ cation.

15. A method of forming a battery or battery precursor comprising a gel layer disposed between a first current collector and a second current collector wherein formation of the gel layer comprises deposition of a solution comprising a solvent, a fluorinated polymer and an alkali or alkali earth metal salt wherein the fluorinated polymer is a partially unsaturated poly(alkylene) polymer claim 1 and evaporation of the solvent.

16. The method according to claim 15 wherein the gel layer is formed over the first current collector and wherein the second current collector is formed over the gel layer.
